(19) United States
(12) Patent Application Publication
(10) Pub. No.: US 2006/0062721 A1
(43) Pub. Date: Mar. 23, 2006

(54) Process of preparing lithium cobalite powders

(76) Inventors: Ming-Tseh Tsay, Longtan Township (TW); Zong-Whie Shih, Longtan Township (TW); Kai-Yia Chang, Longtan Township (TW)

Correspondence Address: RABIN & BERDO, P.C.;Suite 500, 1101 14 Street, N.W., Washington, DC, 20005, US

(21) Appl. No.: 10/945,916

(22) Filed: Sep. 22, 2004

(51) Int. Cl. C01D 1/02

(52) U.S. Cl. 423/594.6

(57) ABSTRACT

A process for preparing lithium cobalite powders uses an oxalate gel method in which lithium nitrate and cobalt nitrate are used as starting reactants, oxalic acid as a chelating agent and water as a solvent. Oxalate sol is formed by the chelating reaction. After poly-condensation is conducted by heating, oxalate gel is formed. Continue heating to remove the solvent and water generated by the reaction to obtain dried gel powders. The dried gel powders are then thermally decomposed and sintered to form lithium cobalite powders LiCoO₂ of a halite-type layered structure.

### BACKGROUND OF THE INVENTION

1. Field of Invention

The invention relates to a process of preparing lithium cobalite powders, and particularly to a process of preparing lithium cobalite powders for use as cathode material for a lithium secondary battery.

2. Related Art

With the demands of reduced weight and size for electronic devices, these electronic devices have become portable and wireless. Among portable devices, those with high-performance lithium ion batteries are mainly high-priced 3C products, such as laptop computers, personal digital assistants, cell phones, digital video cameras, digital cameras, mini CR-ROM players, palm terminals and portable GPS devices.

Cathode materials for lithium secondary batteries include LiCoO₂, LiNiO₂ and LiMn₂O₄. Currently, lithium cobalite is mostly used as the cathode material for the lithium secondary battery. The lithium nickelate has the highest energy density among these materials. However, safety concerns have not yet been completely overcome, so commercialization of lithium nickelate in the field has not yet succeeded. Lithium manganesate has attracted great attention because of its advantages of low price and abundance. However, its capacitance is low and its service life is unsatisfactory.

Lithium cobalite is of a continuous layered α-NaFeO₂ structure with R\overline{3}m configuration. In the structure of lithium cobalite, oxygen atoms are stacked at their largest density, and lithium and cobalt atoms are regularly stacked in gaps between the oxygen atoms to form a continuous layered structure. The lithium ions are able to escape from and enter into LiCoO₂. The theory capacitance is 274 mAh/g.

Actually, not all the lithium ions can escape from and enter into LiCoO₂, because after the lithium ions escape from LiCoO₂, the gap between oxygen and cobalt atoms increases due to repulsion. If the cobalt ions of the cobalt layer do not enter into the stable lithium layer, the original structure collapses due to the release of the lithium ions. In 1992, Gummow et al. taught synthesis of LiCoO₂ at a low temperature of 400° C. Rossen et al. simulated the structure of LiCoO₂ sintered at low temperature and found it to be a spinel. However, LiCoO₂ in a spinel structure has poor thermal stability. Therefore, the application of halite-type layered LiCoO₂ in commercial lithium ion batteries is superior.

Halite-type layered lithium cobalite is obtained mainly by solid-phase and solution processes. The solution process includes a sol-gel process, precipitation process, hydrothermal process and micro-emulsion process.

A high temperature solid-phase process usually mixes oxide, carbonate, and hydroxide salts of lithium and cobalt as starting materials. The lithium and cobalt ions tend to diffuse during a high temperature treatment. Although the solid-phase process is easy, the starting materials are not easily mixed thoroughly by mechanically stirring. In addition, reactants have such large particle diameters that the reactivity is low and a long-term reaction at high temperature is needed. Sintering results are not good because multiple phases are generated with large particle size (particle diameter of about 5-25 μm) and non-uniform particle distribution. Furthermore, some lithium metal evaporates at high temperature, and thus non-stoichiometric products form.

Co-precipitation used to prepare lithium cobalite uniformly distributes precursors in the solution before heat treatment. The atom-level contact of the precursors greatly reduces distance between the precursors to speed up the diffusion and reaction time, which overcomes the disadvantages of the solid-phase process. The small particles adsorb impurities to form aggregates. The starting material can be soluble salt of lithium and cobalt, such as nitrate, chloride and acetate of lithium and cobalts. With precipitation by means of bonding the lithium and cobalt ions in the solution (a) all the lithium and cobalt ions are uniformly distributed and therefore have the same chance to contact each other with no aggregates (ideal precipitation); (b) the lithium ions cannot effectively co-precipitate with the cobalt ions so that the precipitates form non-stoichiometrically, aggregates and fine particles distribute non-uniformly; (c) two or more precipitants are added in the solution to help all the lithium ions and cobalt ions precipitate.

Lithium cobalite obtained by the sol-gel process has high purity, stoichiometry and particle distribution. The sol-gel process includes several types which are categorized according to the starting materials used: (a) metallic alkyloxy process (organic process) in which precursors form colloidal gel; and (b) non-metallic alkyloxy process (inorganic process) in which the precursors form polymeric gel. In the former process, the lithium alkoxide used is easily synthesized and purified, and is highly soluble in an organic solvent. However, the stock material is high in cost and chemically unstable. In the latter, soluble metallic salt of lithium and cobalt used as starting materials is inexpensive but hard to form gel.

Since cost and performance are important concerns with the cathode material in lithium batteries, preparing the cathode material powders of improved particle size, purity, structure and composition is a key point to the success of the lithium secondary battery.

U.S. Pat. No. 5,211,933 discloses a precipitation process for preparing lithium cobalite using cobalt acetate and lithium hydroxide as starting materials, and NH₄OH as a precipitant. Precursors can be thermally decomposed into pure-phase products. However, the precipitation process has the above-mentioned disadvantages.

U.S. Pat. No. 5,914,094 discloses a sol-gel process for preparing lithium cobalite. In this process, PAA is added to a solution containing lithium and cobalt ions to form a gel. The gel is then thermally treated to obtain lithium cobalite. The lithium cobalite obtained by this process has stable chemical properties but low energy density.

U.S. Pat. No. 6,399,041 B1 discloses a hydrothermal process for preparing halite-type layered lithium cobaltate. The hydrothermal process uses high pressure and high temperature in a high-pressure reactor to increase dissolvability and activity of reactants. The solid reactants are thereby dissolved and reacted to obtain powders. The powders obtained have perfect crystalline structures without a sintering stage, so that it is easy to get them by washing or filtering. Since the high pressure reactor is expensive, the process can be conducted only in batches. Therefore, it is not suitable for mass production.

As described above, a process is needed for preparing cathode materials with improved energy density, cycle life and reduced cost.

### SUMMARY OF THE INVENTION

Therefore, one object of the invention is to provide a process of preparing lithium cobalite powders of a halite-type layered structure. A mixed solution of a lithium-containing compound and a cobalt-containing compound is added to an aqueous oxalic acid solution by stirring. With heating, poly-condensation is conducted to form an oxalate gel. After drying and thermal processing, the oxalate gel converts into lithium cobalite powders of a halite-type layered structure.

Another object of the invention is to provide a cathode sheet for a lithium secondary battery by the use of lithium cobalite powders obtained by the process of the invention.

The process of the invention is easy to perform, and the cost of oxalate gel method used in the invention is inexpensive compared to conventional alkoxide sol-gel processes. Furthermore, the sintering temperature is lower than the temperature in solid-phase processes. The product obtained by the process of the invention has uniform composition and high purity, small particle diameter and good crystallinity. Therefore, the lithium secondary batter made of lithium cobalite powders obtained from the invention exhibits high capacity and stability.

### BRIEF DESCRIPTION OF THE DRAWINGS

FIG. 1 is a flowchart for the process of preparing lithium cobalite powders according to the invention;

FIG. 2 is a scanned electronic microscopic photo of a dried gel compound according to a first embodiment of the invention;

FIG. 3 is a thermal weight analysis and differential thermal analysis graph of a gel compound according to a first embodiment of the invention;

FIG. 4 is an X-ray diffraction graph of lithium cobalite powders obtained by sintering precursors at different sintering temperatures according to a first embodiment of the invention;

FIG. 5 is a scanned electron microscopic photo of lithium cobalite powders obtained by sintering precursors at different sintering temperatures according to a first embodiment of the invention;

FIG. 6 is a graph showing the relationship between sintering temperature and surface area of precursors according to a first embodiment of the invention;

FIG. 7 is a graph showing charging/discharging capacity and charging/discharging cycles of lithium cobalite powders obtained at a sintering temperature of 800° C. according to a first embodiment of the invention;

FIG. 8 is a graph showing charging/discharging capacity and charging/discharging cycles of lithium cobalite powders obtained by the precipitation process according to a comparison example 1; and

FIG. 9 is a graph showing charging/discharging capacity and charging/discharging cycles of lithium cobaltate powders obtained by the solid-phase process according to a comparison example 2.

### DETAILED DESCRIPTION OF THE INVENTION

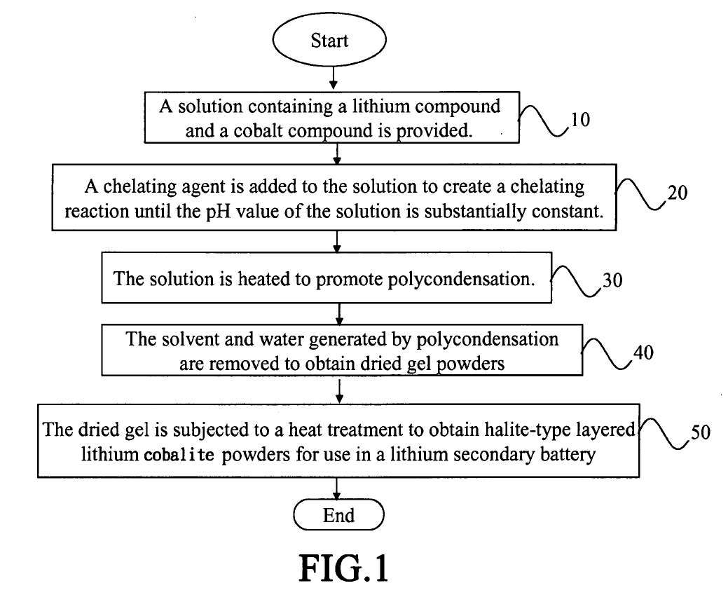

FIG. 1 is a flowchart for the process of preparing lithium cobalite powders according to the invention.

A solution containing a lithium compound and a cobalt compound is provided (step 10). In the invention, lithium and cobalt in the lithium cobaltate powders may come from nitrate or acetate of lithium or cobalt, preferably nitrate of lithium or cobalt. The molar ratio of lithium and cobalt in the solution is 0.95-1.18, and preferably 1.0-1.10. The solvent in the solution can be water, methanol, ethanol, propanol, butanol or glycol. Water is cheaper so better.

A chelating agent is added to the solution to create a chelating reaction until the pH value of the solution is substantially constant (step 20). The chelating agent can be selected from oxalic acid, propylene diacid, butylenes diacid, pentylene diacid, hexylene diacid, heptylene diacid, octylene diacid, nonylene diacid, decylene diacid, tridecylene diacid, hexadecylene diacid, maleamic acid, fumaric acid, pentylene diacid, malic acid, tartaric acid or citric acid. The most preferable chelating agent is oxalic acid. The molar ratio of the feed and total metallic ions (lithium ions and cobalt ions) is 1˜2.5, preferably in the range of 1.1˜1.5. The solution is thoroughly stirred at room temperature to create a chelating reaction until the pH value is substantially constant.

Then, the solution is heated to promote poly-condensation (step 30). The solution is heated to 60° C.˜80° C. while stirring. At that temperature, poly-condensation is performed for 1-3 hours.

The solvent and water generated by poly-condensation are removed to obtain dried gel powders (step 40). Removing the solvent and the water generated by the poly-condensation is not particularly limited, and may be dried at reduced pressure that is well known in the art. Alternatively, the oxalate gel is placed at a temperature higher than room temperature for preliminarily drying. Then, the temperature increases for complete drying so as to obtain the dried oxalate gel powders. The dried gel is subjected to a heat treatment to obtain halite-type layered lithium cobalite powders for use in a lithium secondary battery (step 50). In the heat treatment, the temperature increases from 1˜20° C./min to 550˜850° C. for sintering. The sintering is performed for 2-24 hours to obtain lithium cobalite powders.

The process of creating the lithium cobalite powders by the oxalate gel method can provide uniform and pure lithium cobalite powders with fine particles and high cyrstallinity, density and surface area.

Furthermore, the oxalate obtained from the invention has accomplished part of the reaction. The sintering temperature is reduced. Therefore, the energy needed for subsequent processing is reduced and phase change that may occur at high temperature is prevented.

### EXAMPLE

4.11 g of lithium nitrate, 17.46 g of cobalt nitrate and 15.13 g of oxalic acid are respectively dissolved in 20 ml of de-ionized water. The lithium nitrate aqueous solution and the cobalt nitrate aqueous solution are mixed, and then the oxalic acid aqueous solution is added. The mixed solution is stirred at room temperature until its pH is constant. The solution is heated to 80° C. for 2 hours. Then the temperature is increased to 100° C. to dry up the solution so as to obtain dried gels.

Thereafter, the dried gels are added at 700° C., 750° C., and 800° C. with 10° C./min of temperature increasing rate for 12 hours. Then the sintered powders are air cooled to room temperature. Thereby, lithium cobalite powders formed at different temperatures are obtained.

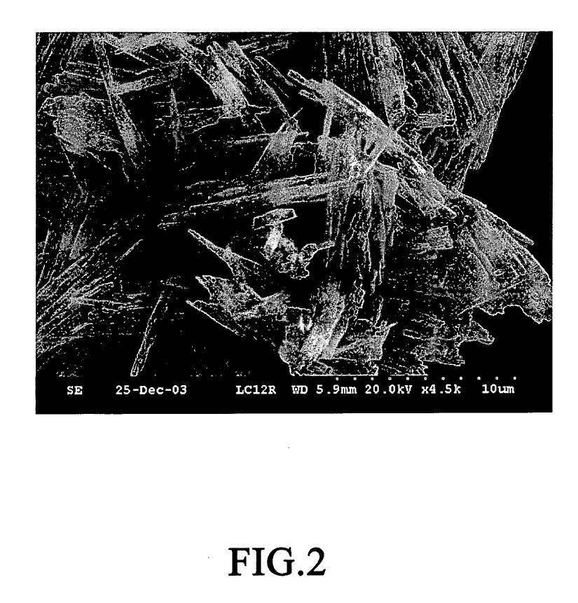

FIG. 2 is a scanned electron microscope picture of dried gel obtained in Example 1. From the picture, it is found that the oxlate gel is in the shape of a tetragonal column.

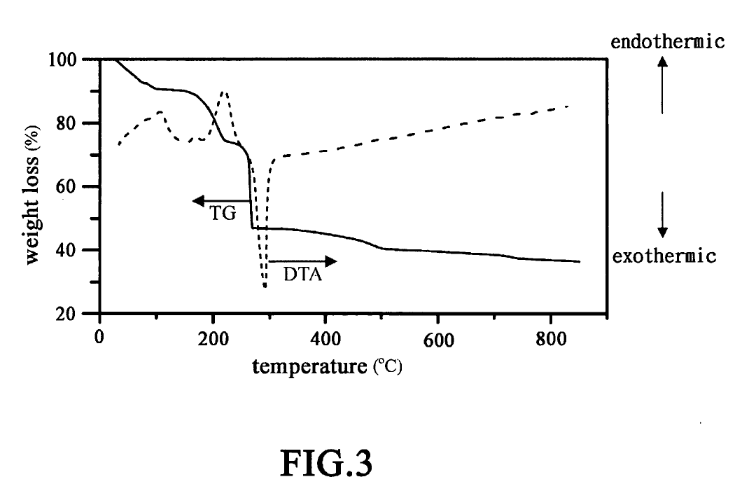

FIG. 3 shows the results of thermal weight analysis and differential thermal analysis of the oxalate gel. As shown in FIG. 3, the curve is divided into four sections. Weight loss before the temperature increases to 100° C. is due to evaporation of moisture molecules from the surface of the gel. The weight loss at 170˜220° C. is due to thermal decomposition of inorganic substances, such as nitrate radicals, in the gel. At 270˜500° C., the residual compound is continuously subjected to thermal decomposition with little change in weight. Once the temperature is higher than 500° C., the weight does not change. That means the thermal decomposition of the gel has been accomplished and the gel starts being sintered.

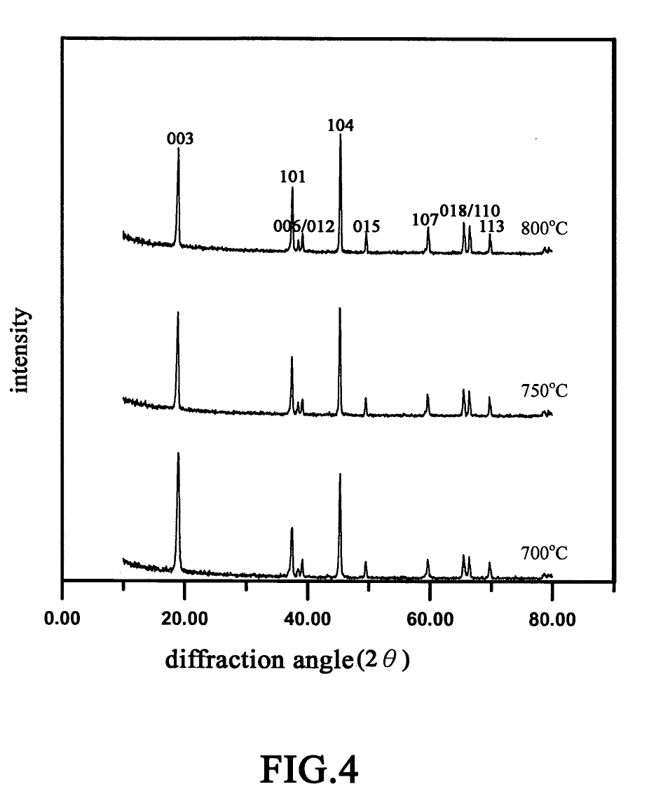

FIG. 4 is an X-ray diffraction graph of oxalate gel powders sintered at different temperatures for 12 hours. The product obtained after the oxalate gel powders are sintered at different temperatures for 12 hours is lithium cobalt single-phase powder. Compared to a standard graph, the obtained product is identified as a layered compound. The higher the sintering temperature, the better the crystallinity and the more apparent the layered structure

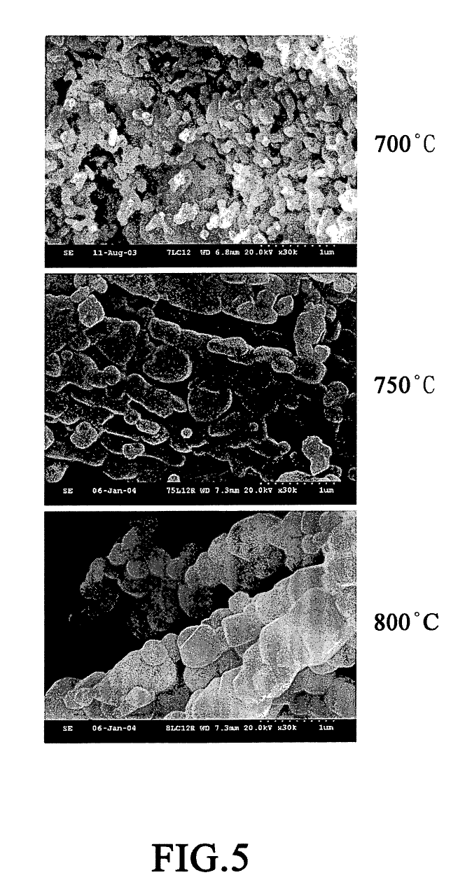

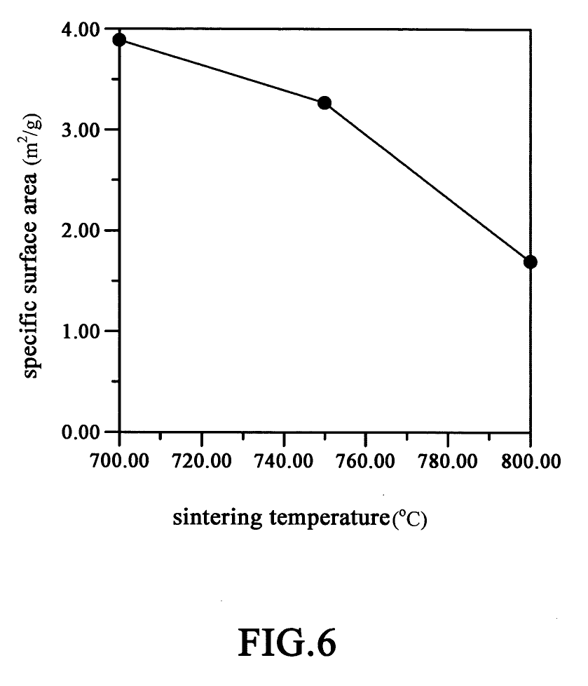

FIG. 5 is a scanned electron microscope picture of oxalate gel powders sintered at different temperatures. As seen from the picture, powders sintered at 700° C. have a particle diameter of about 100 nm, and those at 750° C. and 800° C. have particle diameters of sub-micro order (200˜300 nm). FIG. 6 illustrates the relationship between the sintering temperature and the specific surface area. As shown in FIG. 6, the surface area decreases as the sintering temperature increases.

The lithium cobalite powders obtained from the invention have small particle diameter, large surface area, good crystallnity and high purity.

### EXAMPLE 2

In order to determine the performance of an electrochemical battery made of lithium cobalite powders, the product obtained by sintering at 800° C. in Example 1 is used as a cathode sheet in this example.

The obtained lithium cobalite powders, acetylene and poly o-difluoroethylene are thoroughly mixed at 85:10:5 of weight ratio. N-methyl 2-pyrrolidine (NMP) of the proper amount is added to the above mixture to obtain a uniform paste. The paste is applied over an aluminum foil by a blade. After the foil has been dried for 3 hours, it is rolled and cut into a plurality of cathode sheets.

Lithium metal is used to make the anode sheet of a battery. The electrolyte is a non-aqueous 1M LiPF₆ (ethylene carbonate, diethyl carbonate and dimethyl carbonate at a weight ratio of 1:1:1).

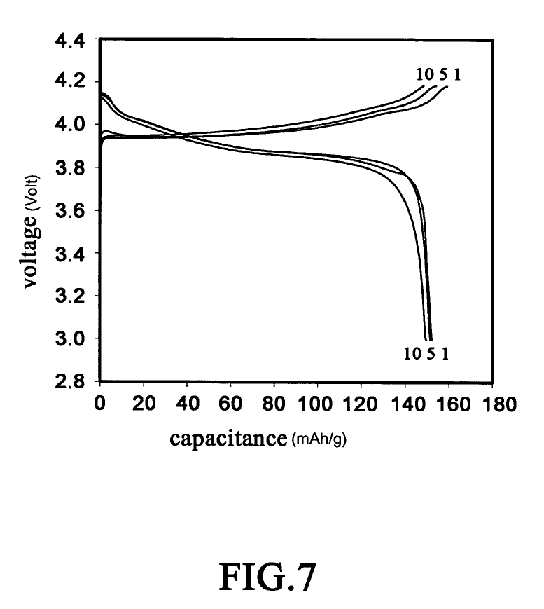

A coin type battery that has been assembled is subjected to an electrochemical analysis by means of Arbin BT2000, at a charging rate of 0.1 C and a stopping voltage of 3.0V-4.2V. The results are shown in FIG. 7. From FIG. 7, it is found that the first charging capacitance is up to 153 mAh/g, and the charge retaining rate reaches 98% even after 10 charging/discharging cycles. The results prove the products obtained from the invention have high energy density and stability. Therefore, the products can improve the performance of the lithium ion secondary battery.

The following comparison examples use precipitation and solid-phase, respectively, to obtain lithium cobalite powders. Elctrochemical properties of the lithium cobalite powders obtained in the comparison examples are determined for comparison.

### COMPARISON EXAMPLE 1

In this comparison example, the lithium cobalite powders are obtained by precipitation. 4.10 g of lithium nitrate and 17.44 g of cobalt nitrate are respectively dissolved in 20 ml of de-ionized water. The lithium nitrate aqueous solution and the cobalt nitrate aqueous solution are mixed after they are completely dissolved in the solution respectively. Then add 9.6 g ammonium hydroxide (28%) into the mixed solution. Precipitates are collected therefrom and then dried to obtain powders.

The powders are heated in the air at an increasing temperature rate of 10° C./min to a maximum of 800° C., and then kept at constant temperature for 12 hours. Then, the powders are air cooled to room temperature to obtain lithium cobalite powders.

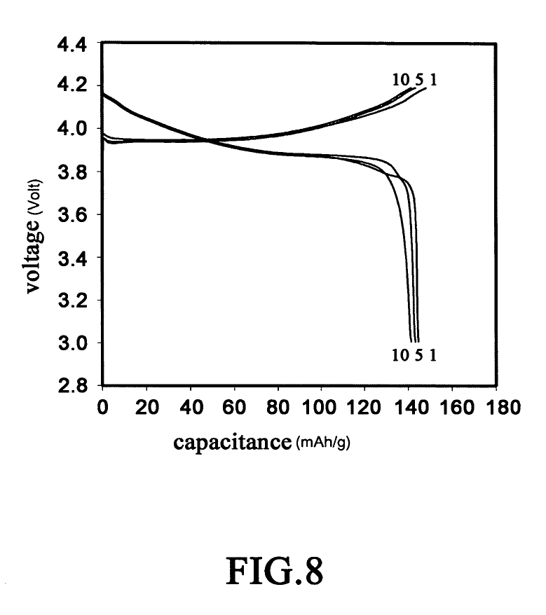

The obtained lithium cobalite powders are made into sheets in the same manner as that in Example 2. A coin type battery is subjected to performance tested after it has been assembled. The results are shown in FIG. 8. It is found that the first discharging capacitance is 145 mAh/g, and the charge retaining rate is 96% after 10 charging/discharging cycles.

### COMPARISON EXAMPLE 2

In this example, the lithium cobalite powders are obtained by solid-phase processes. 2.11 g of lithium carbonate and 6.42 g of cobalt carbonate are mixed in a ball mill and then tablets. The tablets are placed in a high temperature furnace in an air atmosphere. The tablets are heated at an increasing temperature rate of 10° C./min to 900° C., and kept at a constant temperature for 24 hours. Then the tablets are air cooled to room temperature to obtain lithium cobalite powders.

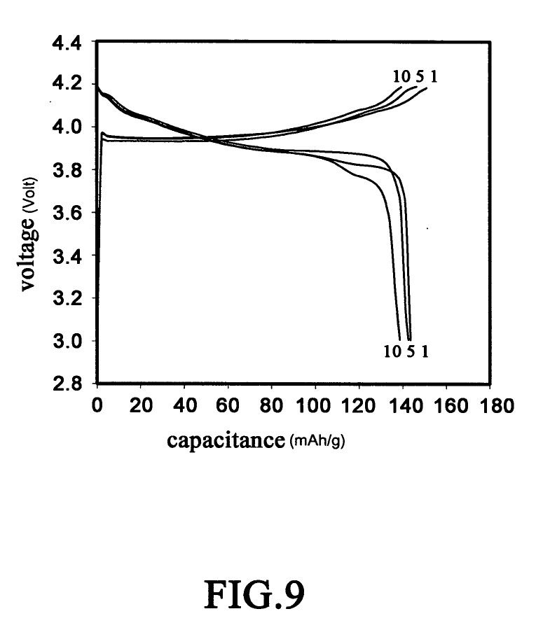

The obtained lithium cobalite powders are made into sheets in the same manner as that in Example 2. A coin type battery is subjected to performance tests after it has been assembled. The results are shown in FIG. 9. It is found that the first discharging capacitance is 141 mAh/g, and the charge retaining rate is 95% after 10 charging/discharging cycles.

What is claimed is:

1. A process of preparing lithium cobalite powders, comprising the following steps:
(a) providing a solution containing a lithium compound and a cobalt compound;
(b) adding a chelating agent into the solution while stirring to conduct a chelating reaction until the pH value of the solution is substantially constant;
(c) heating the solution to promote a poly-condensation reaction to form a gel;
(d) removing the water in the solution and generated by the poly-condensation reaction to obtain dried gel; and
(e) thermal treatment the dried gel in the air to obtain lithium cobalite powders.

2. The process of preparing lithium cobalite powders of claim 1, wherein the lithium compound is selected from one of the group consisting of lithium nitrate and lithium acetate.

3. The process of preparing lithium cobalite powders of claim 1, wherein the cobalt compound is selected from the group consisting of cobalt nitrate and cobalt acetate.

4. The process of preparing lithium cobalite powders of claim 1, wherein at step (a), the molar ratio of lithium and cobalt in the lithium compound and the cobalt compound is in the range of 0.95-1.18.

5. The process of preparing lithium cobalite powders of claim 1, wherein the chelating agent is one selected from the group consisting of oxalic acid, propylene diacid, butylenes diacid, pentylene diacid, hexylene diacid, heptylene diacid, octylene diacid, nonylene diacid, decylene diacid, tridecylene diacid, hexadecylene diacid, maleamic acid, fumaric acid, pentylene diacid, malic acid, tartaric acid and citric acid.

6. The process of preparing lithium cobalite powders of claim 5, wherein the chelating agent is oxalic acid and the salt gel is oxalate salt gel.

7. The process of preparing lithium cobalite powders of claim 6, wherein the molar ratio of oxalic acid and the total lithium/cobalt ions is in the range of 1-2.5.

8. The process of preparing lithium cobalite powders of claim 1, wherein at step (b), the chelating reaction is conducted at room temperature.

9. The process of preparing lithium cobalite powders of claim 1, wherein at step (c), the solution is heated to 60-80° C.

10. The process of preparing lithium cobalite powders of claim 9, wherein the heating time is 1-3 hours.
